(19) United States
(12) Patent Application Publication
(10) Pub. No.: US 2024/0377874 A1
(43) Pub. Date: Nov. 14, 2024

(54) METHOD AND DEVICE FOR CUTTING OFF POWER SUPPLY OF HEATED CLOTHING BASED ON UNDRESSING DETECTION

(71) Applicant: GUANGZHOU ISSYZONE TECHNOLOGY CO.,LIMITED, Guangzhou (CN)

(72) Inventors: TAIPING YANG, Shenzhen (CN); YALEI ZHU, Pingdingshan (CN)

(21) Appl. No.: 18/206,854

(22) Filed: Jun. 7, 2023

(30) Foreign Application Priority Data
May 11, 2023 (CN) 202310529618.6

(51) Int. Cl. G06F 1/3231; H05B 3/34

(52) U.S. Cl. CPC G06F 1/3231; H05B 3/342; H05B 2203/036

(57) ABSTRACT

The present application discloses a method for cutting off power supply of heated clothing based on undress detection, comprising the following steps: setting a countdown for a preset time, and continuously detecting the user's breathing movement within the preset time, if no breathing movement is present within the preset time, then triggering to cut off a power input of a heating module. The beneficial effect of the present application is: to continuously detect the breathing movement of the human body. When the user takes off his clothes, if there is no movement trigger within the preset time, the power input for the heating module will be cut off to reduce the meaningless power consumption of the mobile power supply, so as to achieve the purpose of energy saving.

### CROSS-REFERENCE TO RELATED APPLICATIONS

This application claims the benefit and priority of Chinese patent application No. 202310529618.6, filed on May 11, 2023, disclosure of which is hereby incorporated by reference in its entirety.

### TECHNICAL FIELD

The present application relates to the technical field of smart clothing, in particular to a method and device for cutting off the power supply of heated clothing based on undressing detection.

### BACKGROUND

Existing heated clothing products are mainly used in cold outdoor environments, which are powered by a mobile power supply, and the electric control board system controls the heating sheet sewn on the clothing to generate heat, so as to provide heat for the user's body surface. The generally designed battery can be used for heating clothes for 4-5 hours. After the power consumption is completed, the mobile power supply needs to be recharged. After the user enters the indoor warm place from the cold outdoor place, due to the increase of the ambient temperature, the user will naturally take off the heated clothing. However, according to the feedback from the vast majority of users, they often forget to turn off the power supply of the heated clothing after entering the room, which causes the battery power to be wasted, and the mobile power supply has no power to use when going out for use next time.

### SUMMARY

In view of the above problems, the present application proposes a method and device for cutting off the power supply of heated clothing based on undressing detection, which mainly solves the problem that existing heated clothing products do not have the function of automatically cutting off the power input.

To solve the above technical problems, the first aspect of the present application proposes a method for cutting off the power supply of heated clothing based on undressing detection, which comprises the following steps:

Setting a countdown for a preset time, and continuously detecting the user's breathing movement within the preset time, if no breathing movement is present within the preset time, then triggering to cut off a power input for a heating module.

In some implementations, the countdown of the preset time is reset after each detection of the breathing movement.

In some implementations, the preset time is set to 3-5 minutes.

In some implementations, the detection of the breathing movement comprising: acquiring its own three-axis data at intervals by a three-axis acceleration sensor arranged in a heated clothing, reading the three-axis data at intervals, sequentially splicing, reversing, and taking absolute values, and de-shaking processing, obtaining a corresponding motion posture, counting whether an average angle change of a plurality of the motion postures exceeds 3 degrees of deflection within the preset time, if not, determining that no breathing movement is present and triggering to cut off the power input for the heating module.

In some implementations, it further comprises: accumulating a number of breathing movements within the preset time, determining whether the number of breathing movements reaches a threshold, and triggering to cut off the power input for the heating module if the number of breathing movements does not reach the threshold.

In some implementations, the threshold is set to 3 to 5 times.

In some implementations, the detection of the breathing movement comprises: acquiring its own three-axis data at intervals by a three-axis acceleration sensor arranged in a heated clothing, if a discrete three-axis data forms a stable cycle in a time direction, accumulating each cycle as one breathing movement.

The second aspect of the present application proposes a device for cutting off power supply of heated clothing based on undressing detection comprising:

A time preset module, configured to set a countdown of a preset time;

An movement detection module, configured to continuously detect a breathing movement of a user within the preset time;

A power cut-off module, configured to determine whether the breathing movement is present within the preset time, and if not, trigger to cut off a power input for a heating module.

The third aspect of the present application proposes device for cutting off power supply of heated clothing based on undressing detection, comprising a memory, a processor and a communication module, wherein,

The memory is configured to store executable program codes;

The processor is coupled to the memory;

The processor is configured to invoke the executable program code stored in the memory to execute the above mentioned method for cutting off the power supply of heated clothing based on undressing detection.

The fourth aspect of the present application proposes a computer storage medium, wherein the computer storage medium stores computer instructions, and when the computer instructions are invoked, computer instructions execute the above mentioned method for cutting off power supply of heated clothing based on undressing detection.

The beneficial effect of the present application is: to continuously detect the breathing movement of the human body. When the user takes off his clothes, if there is no movement trigger within the preset time, the power input for the heating module will be cut off to reduce the meaningless power consumption of the mobile power supply, so as to achieve the purpose of energy saving.

### BRIEF DESCRIPTION OF DRAWINGS

FIG. 1 is a schematic flow chart of a method for cutting off the power supply of heated clothing based on undressing detection disclosed in a first Embodiment of the present application;

FIG. 2 is a schematic flow chart of another method for cutting off the power supply of heated clothing based on undressing detection disclosed in a second Embodiment of the disclosure of the present application;

FIG. 3 is a schematic structural diagram of a device for cutting off power supply of heated clothing based on undressing detection disclosed in a third Embodiment of the present application;

FIG. 4 is a schematic structural diagram of another device for cutting off power supply of heated clothing based on undressing detection disclosed in a fourth Embodiment of the present application.

### DETAILED DESCRIPTION

The technical solution in the embodiment of the present application will be clearly and completely described below in conjunction with the accompanying drawings in the embodiment of the present application. Apparently, the described embodiments are only some of the embodiments of the present application, rather than all the embodiments. Based on the embodiments in the present application, all other embodiments obtained by a person skilled in the art without making creative efforts belong to the protection scope of the present application.

It should be understood that when used in this specification and the appended claims, the terms “comprising” and “comprises” indicate the presence of described features, integers, steps, operations, elements and/or components, but do not exclude the existence or addition of one or more other features, integers, steps, operations, elements, components and/or collections thereof.

It should also be understood that the terminology used in the specification of the present application is for the purpose of describing particular embodiments only and is not intended to limit the present application. As used in this specification and the appended claims, the singular forms “a”, “an” and “the” are intended to include plural referents unless the context clearly dictates otherwise.

It should also be further understood that the term “and/or” used in the description of the present application and the appended claims refers to any combination and all possible combinations of one or more of the associated listed items, and includes these combinations.

As used in this specification and the appended claims, the term “if” may be construed as “when” or “once” or “in response to determining” or “in response to detecting” depending on the context. Similarly, the phrase “if determined” or “if [the described condition or event] is detected” may be construed, depending on the context, to mean “once determined” or “in response to the determination” or “once detected [the described condition or event]” or “in response to detection of [described condition or event]”.

### First Embodiment

This embodiment proposes a method for cutting off the power supply of heated clothing based on undressing detection, which continuously detects the breathing movement of the human body. When the user takes off the clothes, if there is no movement trigger within the preset time, the power supply for the heating module will be cut off to reduce the meaningless power consumption of the mobile power supply, so as to achieve the purpose of energy saving.

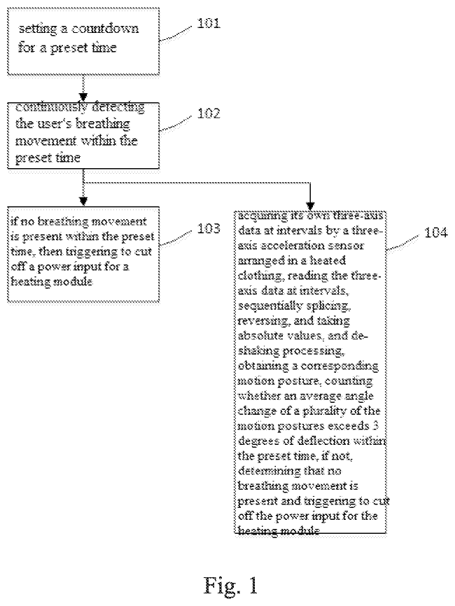

Please refer to FIG. 1. FIG. 1 is a schematic flow chart of a method for cutting off the power supply of heated clothing based on undressing detection disclosed in an embodiment of the present application. As shown in FIG. 1, the method for cutting off the heated clothing power supply based on undressing detection comprises the following steps:
101. Setting a countdown of a preset time.

In this embodiment, the heated clothing should be provided with a single-chip microcomputer control module for controlling the heated clothing. This solution is designed based on the original single-chip microcomputer architecture, and the original hardware is used as much as possible to increase the power cut-off function. Specifically, in step 101, the preset time can be manually set, such as burning into the single-chip microcomputer through a program, or written into the single-chip microcomputer by the user through the mobile phone APP. After the preset time is set, generate a subroutine to run. This subroutine is parallel to the main program of heated clothing to count down, and determines whether to cut off the power according to the subsequent trigger conditions, and the preset time is set to 3-5 minutes.
101. Continuously detecting the breathing movement of the user within the preset time.

There may be various means for detecting the user's breathing movement, such as detecting the airflow in the user's nasal cavity, or the rise and fall of the chest cavity. In this embodiment, in order to reduce the cost of the detection device and reduce the volume of the product, a three-axis acceleration sensor is used to obtain the user's chest rise and fall, or the acceleration generated when the human body moves. It should be known that the detection of breathing movement is a technical means, and its purpose is still to reflect the state of the heated clothing, whether it is put on or taken off by the user.
103. If there is no breathing movement within the preset time, triggering to cut off the power input for the heating module.

In this embodiment, the heating module specifically refers to a heating sheet, a heating wire, or other forms of heating devices installed in the heated clothing. If no breathing movement is detected within the preset time, the power input for the heating module will be triggered to be cut off. When the power supply for the heating module is cut off, the power consumption of the entire heated clothing will drop precipitously, and only the single-chip microcomputer will keep running with low power consumption. If a breathing movement is detected within the preset time, the countdown of the preset time will be reset after each detection of the breathing movement, and the above subroutine will start counting down again. That is to say, every time a breathing movement is detected, there will be a heating time of at least 3 minutes (assuming the preset time is set to 3 minutes). If the user needs to leave immediately after entering the room for a short time, she/he can directly put on the heated clothing and leave without restarting the heating or waiting for the heated clothing to reach the expected temperature.

In this embodiment, one of the alternative implementations is provided to replace or supplement step 103, 104. The detection of the breathing movement comprising: acquiring its own three-axis data at intervals by a three-axis acceleration sensor arranged in a heated clothing, reading the three-axis data at intervals, sequentially splicing, reversing, and taking absolute values, and de-shaking processing, obtaining a corresponding motion posture, counting whether an average angle change of a plurality of the motion postures exceeds 3 degrees of deflection within the preset time, if not, determining that no breathing movement is present and triggering to cut off the power input for the heating module. In this alternative, the condition for power cutoff is to count whether the average angle change of a plurality of the motion postures exceeds 3 degrees of deflection within a preset time, the average angle change can effectively reflect whether the heated clothing is actually taken off. Even if the heated clothing is taken off and located in an unstable environment (for example, the heated clothing is placed on the back of the seat and then falls to the ground), the angle deflection will not exceed 3 degrees within the preset time of 3 minutes deflection. Even if the posture of the heated clothing changes in a short period of time, it will stabilize quickly without human intervention. Therefore, it will be reset at the beginning of the preset time, and the power will be cut off within 3-5 minutes.
In step 104, the three-axis data obtained by the three-axis acceleration sensor is used to characterize the breathing movement of the user, thereby indirectly reflecting the state of the heated clothing.

### Second Embodiment

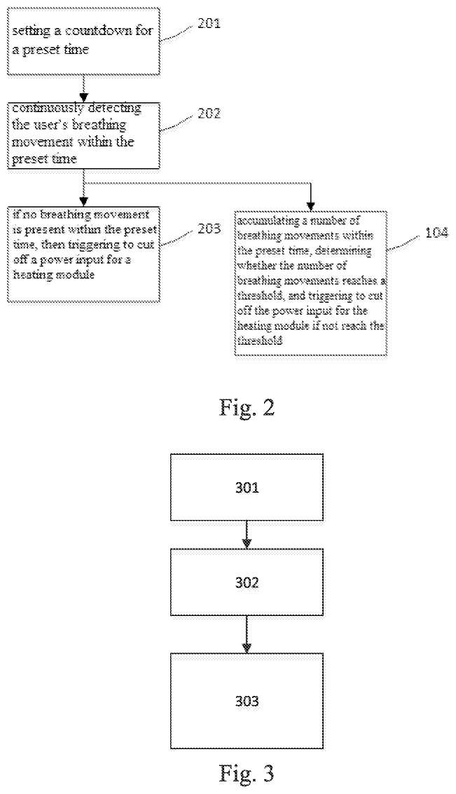

Please refer to FIG. 2. FIG. 2 is a schematic flow chart of another method for cutting off the power supply of heated clothing based on undressing detection disclosed in the embodiment of the present application. As shown in FIG. 2, the method for cutting off the power supply of heated clothing based on undressing detection comprises the following steps:
201. Setting a countdown of a preset time.
202, Continuously detecting the breathing movement of a user within a preset time.
203. If there is no breathing movement within the preset time, triggering to cut off a power input for the heating module.

For the above steps 201 to 203, please refer to the detailed description of steps 101 to 103 in the first Embodiment, which will not be repeated in this embodiment of the present application.

In this embodiment, another further optional implementation is provided to replace or supplement step 203, which also includes the following step 204.

In Step 204, accumulating a number of breathing movements within the preset time, determining whether the number of breathing movements reaches a threshold, and triggering to cut off the power input for the heating module if the number of breathing movements does not reach the threshold. In order to avoid falsely triggering the power cutoff operation and putting the user in danger of hypothermia, this embodiment proposes the concept of “breathing frequency threshold”. By detecting the number of accumulated breathing movements within a preset time, it is detected whether the heated clothing is actually worn by the user. Specifically, based on experience, the threshold should be set to 3 to 5 times within 3 minutes, and if the preset time is increased to 5 minutes, the threshold should be set to more than 10 times. Obviously, in some extreme situations in the wild, the user may be about to suffer extreme threats and have to reduce his own breathing rate, so an excessively high threshold should not be used to determine whether the heated clothing is still worn on the user.

Specifically, the detection of the breathing movement comprises: acquiring its own three-axis data at intervals by a three-axis acceleration sensor arranged in a heated clothing, if a discrete three-axis data forms a stable cycle in a time direction, accumulating each cycle as one breathing movement. In this alternative, only three-axis data that stably form a complete cycle can be identified as breathing movement.

### Third Embodiment

Please refer to FIG. 3. FIG. 3 is a schematic structural diagram of another device for cutting off power supply of heated clothing based on undressing detection disclosed in a third Embodiment of the present application. As shown in FIG. 3, the device for cutting off power supply of heated clothing based on undressing detection comprises:

A time preset module 301, configured to set the countdown of the preset time.

In this embodiment, the heated clothing should be equipped with a single-chip microcomputer control module for controlling the heated clothing. This solution is designed based on the original single-chip microcomputer architecture, and the original hardware is used as much as possible to increase the power cut-off function. Specifically, the time preset module 301 can be a peripheral hardware module of the single-chip microcomputer, or a software module embedded in the single-chip microcomputer. The above-mentioned preset time can be set manually, such as burning it into the single-chip microcomputer through a program, or writing into the single-chip microcomputer by the user through the mobile phone APP. After the preset time is set, generate a subroutine to run. This subroutine is parallel to the main program of heated clothing to count down, and determines whether to cut off the power according to the subsequent trigger conditions, and the preset time is set to 3-5 minutes.

A motion detection module 302, configured to continuously detect the breathing motion of the user within a preset time.

In this embodiment, in order to reduce the overall cost of the detection device and reduce the volume of the product, a three-axis acceleration sensor is used as the motion detection module 302 to obtain the user's chest rise and fall, or the acceleration generated when the human body moves, and, the acquired data is actively read by the above-mentioned single-chip microcomputer.

A power cut-off module 303, configured to determine whether there is a breathing movement within a preset time, and if not, triggering to cut off the power input for the heating module.

In this embodiment, the power cut-off module 303 needs to have at least two functions, one is the logical operation function for determining whether there is a breathing movement within a preset time, and the other is the data sending function, which sends the instruction to cut off the power input to the data receiving end of the power supply, physically disconnects the current between the heated clothing and the power supply, and provides a reliable cut-off action.

In this embodiment, the specific execution logic of the power cut-off module can refer to the first Embodiment or the second Embodiment, which will not be repeated here.

### Fourth Embodiment

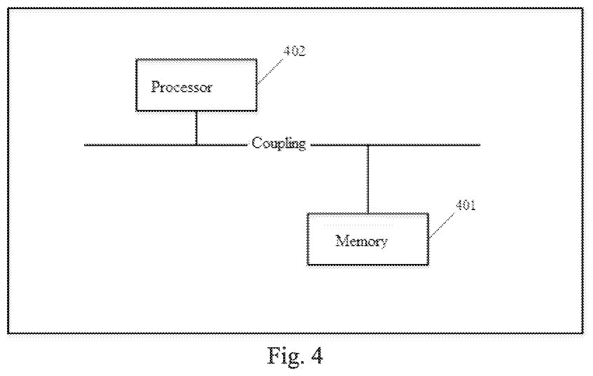

Please refer to FIG. 4. FIG. 4 is a schematic structural diagram of another device for cutting off power supply of heated clothing based on undressing detection in an embodiment of the present application. As shown in FIG. 4, the device may comprise:
A memory 401 storing executable program codes;
A processor 402 coupled to the memory 401;
The processor 402 invokes the executable program code stored in the memory 401 to execute the steps in the method for cutting off the power of heated clothing based on undressing detection described in any one of the first Embodiment or the second Embodiment 2.

### Fifth Embodiment

The embodiment of the present application discloses a computer program product, the computer program product includes a non-transitory computer-readable storage medium storing a computer program, and the computer program is operable to make the computer execute the steps in the method for cutting off the power supply of heated clothing based on undressing detection described in any one of the first or second embodiment.

The device embodiments described above are only illustrative, and the modules described as separate components may or may not be physically separated, and the components shown as modules may or may not be physical modules, that is, they may be located in one place, or it can be distributed to multiple network modules. Part or all of the modules can be selected according to actual needs to achieve the purpose of the solution of this embodiment. It can be understood and implemented by those skilled in the art without any creative effort.

Through the specific description of the above embodiments, those skilled in the art can clearly understand that each implementation manner can be implemented by means of software plus a necessary general-purpose hardware platform, and of course also by hardware. Based on this understanding, the essence of the above technical solution or the part that contributes to the existing technology can be embodied in the form of software products. The computer software product can be stored in a computer-readable storage medium, and the storage medium includes Read-Only Memory (ROM), Random Access Memory (RAM), Programmable Read-only Memory (PROM), Erasable Programmable Read Only Memory (EPROM), One-time Programmable Read-Only Memory (OTPROM), Electronically Erasable Rewritable Read-Only Memory (EEPROM), CD-ROM (Compact Disc Read-Only Memory) or other optical disc storage, magnetic disk storage, tape storage, or any other computer-readable medium that can be used to carry or store data.

Finally, it should be noted that: a Bluetooth control method and device for heated clothing disclosed in the embodiment of the present application is only a preferred embodiment of the present application, and is only used to illustrate the technical solution of the present application, not to limit it. Although the present application has been described in detail with reference to the aforementioned embodiments, those skilled in the art should understand that they can still modify the technical solutions described in the aforementioned embodiments, or perform equivalent replacements for some of the technical features. However, these modifications or replacements do not make the essence of the corresponding technical solutions deviate from the spirit and scope of the technical solutions of the various embodiments of the present application.

The above-mentioned embodiments are just to illustrate the technical concept and features of the present application, and the purpose is to enable those of ordinary skill in the art to understand the content of the present application and implement it accordingly, and not to limit the protection scope of the present application. All equivalent changes or modifications made according to the essence of the content of the application shall fall within the protection scope of the present application.

What is claimed is:

1. A method for cutting off power supply of heated clothing based on undressing detection, comprising following steps:
Setting a countdown for a preset time, and continuously detecting the user's breathing movement within the preset time, if no breathing movement is present within the preset time, then triggering to cut off a power input for a heating module.

2. The method for cutting off power supply of heated clothing based on undressing detection according to claim 1, wherein the countdown of the preset time is reset after each detection of the breathing movement.

3. The method for cutting off power supply of heated clothing based on undressing detection according to claim 1, wherein the preset time is set to 3-5 minutes.

4. The method for cutting off power supply of heated clothing based on undressing detection according to claim 1, wherein the detection of the breathing movement comprising: acquiring its own three-axis data at intervals by a three-axis acceleration sensor arranged in a heated clothing, reading the three-axis data at intervals, sequentially splicing, reversing, and taking absolute values, and de-shaking processing, obtaining a corresponding motion posture, counting whether an average angle change of a plurality of the motion postures exceeds 3 degrees of deflection within the preset time, if not, determining that no breathing movement is present and triggering to cut off the power input for the heating module.

5. The method for cutting off power supply of heated clothing based on undressing detection according to claim 1, wherein further comprising: accumulating a number of breathing movements within the preset time, determining whether the number of breathing movements reaches a threshold, and triggering to cut off the power input for the heating module if the number of breathing movements does not reach the threshold.

6. The method for cutting off power supply of heated clothing based on undressing detection according to claim 5, wherein the threshold is set to 3 to 5 times.

7. The method for cutting off power supply of heated clothing based on undressing detection according to claim 5, wherein the detection of the breathing movement comprises: acquiring its own three-axis data at intervals by a three-axis acceleration sensor arranged in a heated clothing, if a discrete three-axis data forms a stable cycle in a time direction, accumulating each cycle as one breathing movement.

8. A device for cutting off power supply of heated clothing based on undressing detection comprising:
A time preset module, configured to set a countdown of a preset time;
An movement detection module, configured to continuously detect a breathing movement of a user within the preset time;
A power cut-off module, configured to determine whether the breathing movement is present within the preset time, and if not, trigger to cut off a power input for a heating module.

9. A device for cutting off power supply of heated clothing based on undressing detection, comprising a memory, a processor and a communication module, wherein,
the memory is configured to store executable program codes;
the processor is coupled to the memory;
the processor is configured to invoke the executable program code stored in the memory to execute the method for cutting off the power supply of heated clothing based on undressing detection according to claim 1.

10. A computer storage medium, wherein the computer storage medium stores computer instructions, and when the computer instructions are invoked, computer instructions execute the method for cutting off power supply of heated clothing based on undressing detection according to claim 1.
